(19) United States
(12) Patent Application Publication
(10) Pub. No.: US 2021/0336457 A1
(43) Pub. Date: Oct. 28, 2021

(54) Modular Power Storage Unit and Related Systems

(71) Applicant: Tier 1 Solar, Inc., Victor, MT (US)

(72) Inventors: Ryan Duarte, Victor, MT (US); Michael Gill, Missoula, MT (US)

(21) Appl. No.: 17/242,208

(22) Filed: Apr. 27, 2021

Related U.S. Application Data
(60) Provisional application No. 63/015,820, filed on Apr. 27, 2020.

(51) Int. Cl. H02J 7/00; H02J 7/35

(52) U.S. Cl. CPC H02J 7/0042; H02J 7/35; H02J 7/0029; H02J 7/0047; H02J 7/0013

(57) ABSTRACT

Systems are presented for modular, scalable storing and delivery of electrical power. Exemplary implementations may include: at least one energy storage device such as a plurality of battery cells or a flywheel energy storage device; an interconnection port configured for connecting the system to one or more other similar systems; one or more charging ports configured collectively to receive electrical power delivered at more than one voltage; and one or more discharge ports configured collectively to discharge electrical power at more than one voltage. In some embodiments, one or more of a solar power generation source, a wind generation source, and a hydroelectric generator may be electrically coupled to the system for supplying energy for charging.

### CROSS-REFERENCE TO RELATED APPLICATIONS

The present application claims priority to U.S. Provisional Patent Application No. 62/015,820, filed Apr. 27, 2020, the contents of which is incorporated by reference herein in its entirety.

### TECHNICAL FIELD

This disclosure relates generally to technological improvements in the field of electrical power storage and, in particular, to modular power storage units and scalable systems incorporating such units.

### BACKGROUND

Conventional off-grid power storage systems, such as for example those used in conjunction with a solar panel array, are traditionally be custom-designed and built based on specific capacity and usage requirements, environment, charging devices, load devices, and other parameters. Such systems are costly, require long lead times, and are often inflexible with respect to any changes in need or environment.

The disadvantages of such custom solutions exclude many would-be consumers from implementing innovative power storage and supply solutions where, for example, connections to a traditional power grid would be difficult or impossible. These disadvantages also have the effect of materially reducing access to renewable and more-sustainable energy for millions of people throughout the world.

Individuals and industry desire access to electrical power in many situations and areas where existing power grids do not reach. Likewise, many energy consumers who do have access to a power grid desire better and more cost-effective solutions for using renewable energy such as solar, wind, and hydroelectric power, among others, with reduced or no reliance on burning fossil fuels for power. A less expensive, easily scalable power storage and supply solution that can receive and distribute power from various sources and in various forms is desirable.

The present disclosure provides systems for modular, scalable power storage and distribution. The system described herein provides power without the limitations of existing power grids or total reliance on fossil fuels. The system accumulates power for use by individuals, households, and small businesses, and can be scaled easily by the end consumer to increase voltage and amperage as needed. The system uses innovative configurations to accumulate electrical power from multiple sources and to allow the distribution of energy in multiple formats.

### SUMMARY

In general, the present disclosure provides systems for modular, scalable storage and delivery of electrical power. One aspect of the present disclosure relates to a modular power storage system including at least one energy storage device; and interconnection port configured for connecting the modular power storage system to one or more other similar systems; one or more charging ports configured collectively to receive electrical power delivered at more than one voltage; and one or more discharge ports configured collectively to discharge electrical power at more than one voltage.

In some embodiments, the one or more charging ports may be configured to accept power from one or more of a solar power generation source, a wind generator, and a hydroelectric generator.

According to some embodiments, the at least one energy storage device includes a plurality of battery cells. According to some embodiments of the present invention, the at least one energy storage device includes flywheel energy storage.

In some embodiments, the system includes a voltage sensing device at at least one input and/or output of the system.

According to some embodiments, the system may include battery management circuitry for safety, charge balancing, discharge balancing, battery cell conditioning, temperature monitoring, or other functions.

According to some embodiments, the one or more charging ports may be configured collectively to receive both alternating current and direct current simultaneously.

According to some embodiments, the one or more discharge ports may be configured collectively to distribute both alternating current and direct current simultaneously.

According to some embodiments, an energy storage system may include a plurality of modular power storage systems, various ones of the modular power storage systems including: at least one energy storage device, an interconnection port configured for connecting the modular power storage system to one or more other modular power storage systems; one or more charging ports configured collectively to receive electrical power delivered at more than one voltage; and one or more discharge ports configured collectively to discharge electrical power at more than one voltage.

An energy storage system according to some embodiments may include a plurality of modular power storage systems, various ones of the modular power storage systems comprising: at least one energy storage device; an interconnection port configured for connecting the modular power storage system to one or more other modular power storage systems; one or more charging ports, the one or more charging ports configured collectively to receive electrical power delivered at more than one voltage; and one or more discharge ports, the one or more discharge ports configured collectively to discharge electrical power at more than one voltage.

According to various embodiments, an energy storage system may further include one or more solar power generation panels electrically coupled to at least one of the one or more charging ports of at least one of the plurality of modular power storage systems; and one or more electrical loads electrically coupled to at least one of the one or more discharge ports of at least one of the plurality of modular power storage systems.

Other technical features may be readily apparent to one skilled in the art from the following figures, descriptions, and claims. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level block diagram of a modular energy storage system including supply and load devices according to some embodiments of this disclosure.

FIG. 2 shows a high-level component diagram of an example scalable energy storage system according to some embodiments of this disclosure.

FIG. 3 is an exterior isometric view of an example modular energy storage system according to some embodiments of this disclosure.

FIG. 4 is an exterior isometric view of another example modular energy storage system according to some embodiments of this disclosure.

### DETAILED DESCRIPTION

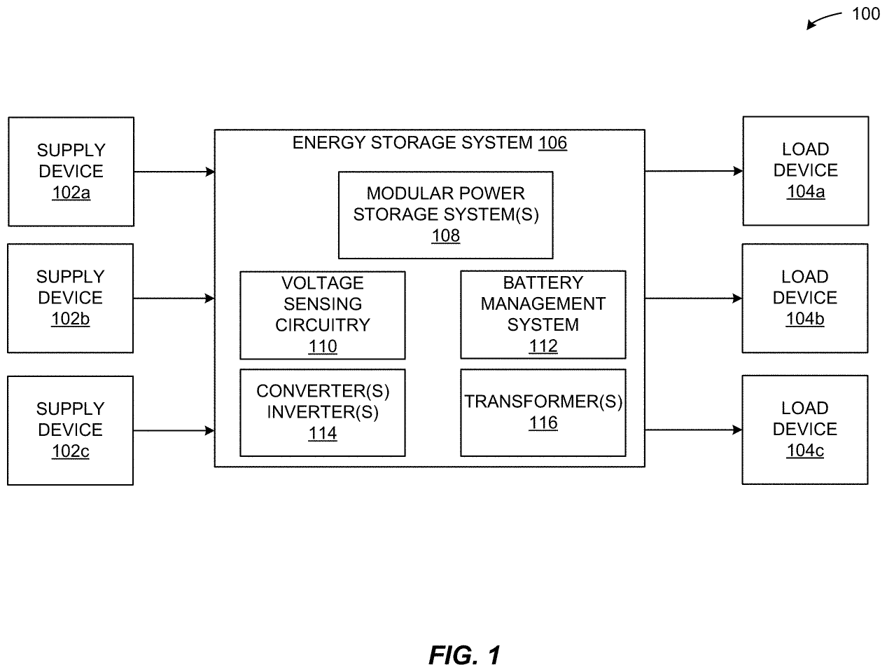

Embodiments of systems for modular, scalable storage and delivery of electrical power are presented. FIGS. 1 through 4, discussed below, and the various embodiments used to describe the principles of this disclosure are by way of illustration only and should not be construed in any way to limit the scope of the disclosure.

FIG. 1 illustrates a high-level block diagram of a modular energy storage system 100 including supply and load devices according to some embodiments of this disclosure.

According to some embodiments, one or more supply devices represented in FIG. 1 by the examples 102a, 102b, and 102c, supply electrical power to energy storage system 106 for storage and/or distribution. According to various embodiments, supply devices 102a-102c may include a solar panel or array of solar panels to generate electrical power from the sun and provide it to energy storage system 106. According to various embodiments, supply devices 102a-102c may include any combination of solar power devices, hydroelectric generation devices, wind turbine generators, traditional grid storage, battery modules, flywheel energy storage devices, or any other suitable power supply device as would be apparent to a person having ordinary skill in the art. According to some embodiments, traditional grid power may supply at least some of the electricity.

According to various embodiments, power may be supplied to energy storage system 106 at one or more of any voltage standards, for example 110V, 120V, 220V, or 240V according to the specifications of the device or devices 102 supplying the power. According to some embodiments, voltage sensing circuitry 110 may detect the input voltage applied to various ports of the energy storage system 106 and adjust the functioning mode(s) of energy storage system 106 as necessary to accommodate the applied voltage(s).

According to various embodiments, one or more power inverters and converters may be included in energy storage system 106 to aid in the storage and distribution of power, for example by converting DC current to AC current and for converting AC current to DC current. According to various embodiments, one or more transformers may be included for altering voltages as necessary between the input, storage, and discharge phases.

According to some embodiments, energy storage system 106 may include one or more battery management systems 112 configured, for example, to monitor temperature, pressure, electrical input and output, and other parameters as necessary for safety. According to various embodiments, battery management system(s) 112 may be further configured to perform charge balancing in the charging or discharging phases, to provide battery conditioning functions to preserve the longevity of battery cells (e.g. lithium ion cells), and other functions as one having ordinary skill in the art would understand.

According to various embodiments, energy storage system 106 may include one or more modular power storage systems 108. Modular power storage systems 108 may include, for example, battery packs or one or more flywheel energy storage devices, or any other suitable energy storage device as would be apparent to a person having ordinary skill in the art.

Each modular storage system 108 according to various embodiments may include an interconnection port for electrically connecting to other similar modular storage systems, thus increasing or decreasing the overall capacity of the energy storage system based on requirements. Accordingly, because each module 108 is capable of receiving and discharging AC and/or DC power at a variety of voltages, even an unsophisticated end user is capable of assembling a suitable system anywhere in the world at a consistent and predictable cost, and without the need for custom design, build, and installation services, or access to a traditional power grid infrastructure. The resulting system is also highly flexible and portable, able to be scaled up and down without waste of modules or components.

According to some embodiments, one or more load devices as represented at FIG. 1 by devices 104a, 104b, and 104c may be configured to draw electrical power from energy storage system 106. Devices 104a-104c may include at least one of a mobile phone, a computer, household appliances, electronics, an electric or hybrid vehicle, or nearly any other type of power-consuming device.

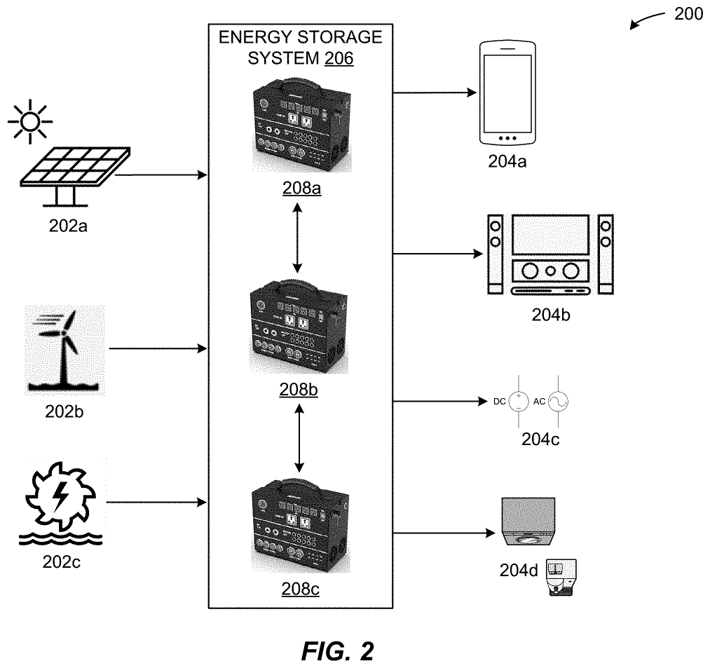

FIG. 2 shows a high-level component diagram of an example scalable energy storage system 200 according to some embodiments of this disclosure. According to various embodiments, energy storage system 206 may include one or more modular power storage systems represented in FIG. 2 by systems 208a, 208b, and 208c. Modular power storage systems 208a-208c may include, for example, battery packs or one or more flywheel energy storage devices, or any other suitable energy storage device as would be apparent to a person having ordinary skill in the art.

Each modular storage system 208a-208c according to various embodiments may include an interconnection port for electrically connecting to other similar modular storage systems, thus increasing or decreasing the overall capacity of the energy storage system based on requirements. Accordingly, because each module 208 is capable of receiving and discharging AC and/or DC power at a variety of voltages, even an unsophisticated end user is capable of assembling a suitable system anywhere in the world at a consistent and predictable cost, and without the need for custom design, build, and installation services, or access to a traditional power grid infrastructure. The resulting system is also highly flexible and portable, able to be scaled up and down without waste of modules or components.

According to some embodiments, one or more supply devices represented in FIG. 2 by the examples 202a, 202b, and 202c, supply electrical power to energy storage system 206 for storage and/or distribution. According to various embodiments, supply devices 202a-202c may include a solar panel or array of solar panels to generate electrical power from the sun and provide it to energy storage system 206. According to various embodiments, supply devices 202a-202c may include any combination of solar power devices, hydroelectric generation devices, wind turbine generators, traditional grid storage, battery modules, flywheel energy storage devices, or any other suitable power supply device as would be apparent to a person having ordinary skill in the art. According to some embodiments, traditional grid power may supply at least some of the electricity.

According to some embodiments, one or more load devices as represented at FIG. 2 by devices 204a, 204b, 204c, and 204d may be configured to draw electrical power from energy storage system 206. Devices 204a-204d may include at least one of a mobile phone, a computer, a household appliances, electronics, an electric or hybrid vehicle, or nearly any other type of power-consuming device.

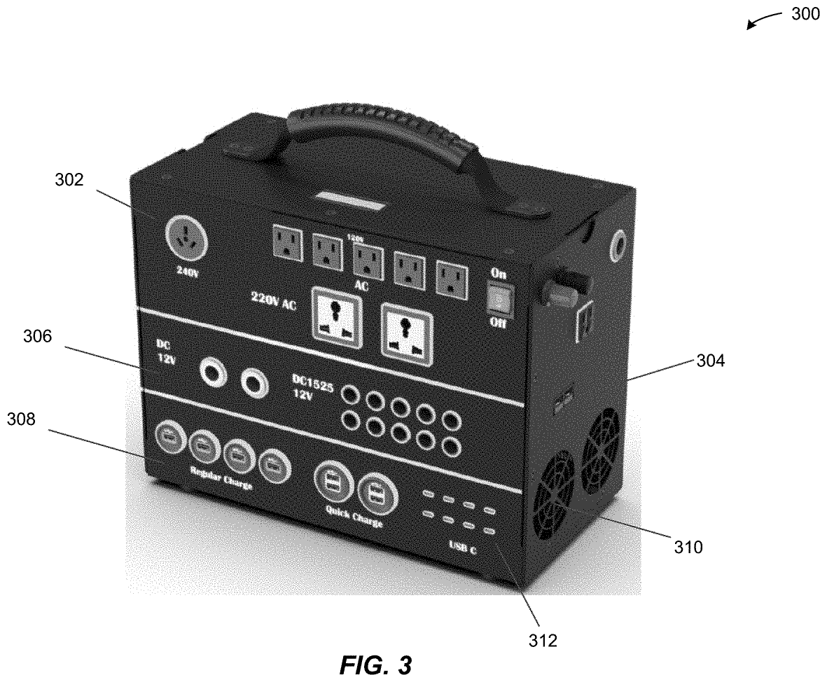

FIG. 3 is an exterior isometric view of a modular energy storage system 300 according to some embodiments of this disclosure. According to some embodiments, various ones of system 300 may include one or more battery packs including a plurality of battery cells, one or more flywheel storage devices, or any other suitable electrical storage device as would be apparent to one having ordinary skill in the art.

According to some embodiments, a panel section 302 includes a variety of plug-in ports including 240V and 220V AC, 120V AC, etc. A supply power switch is further provided according to some embodiments.

According to various embodiments, a panel section 306 provides direct current outputs at DC 12V, and for example DC1525 ports.

According to some embodiments, a panel section 308 of the system 300 may provide standard and fast-charging USB ports, as well as several USBC ports 312 for charging.

According to various embodiments, an interconnection 304 is provided for connecting the system 300 to other similar systems. In some embodiments, the port 304 may be an Anderson port or another suitable type of interconnection port or cable as would be apparent to one having ordinary skill in the art.

According to various implementations, one or more ventilation grates 310 may be included as a part of system 300. According to some embodiments, one or more fans for air circulation may be included in an energy or power storage system.

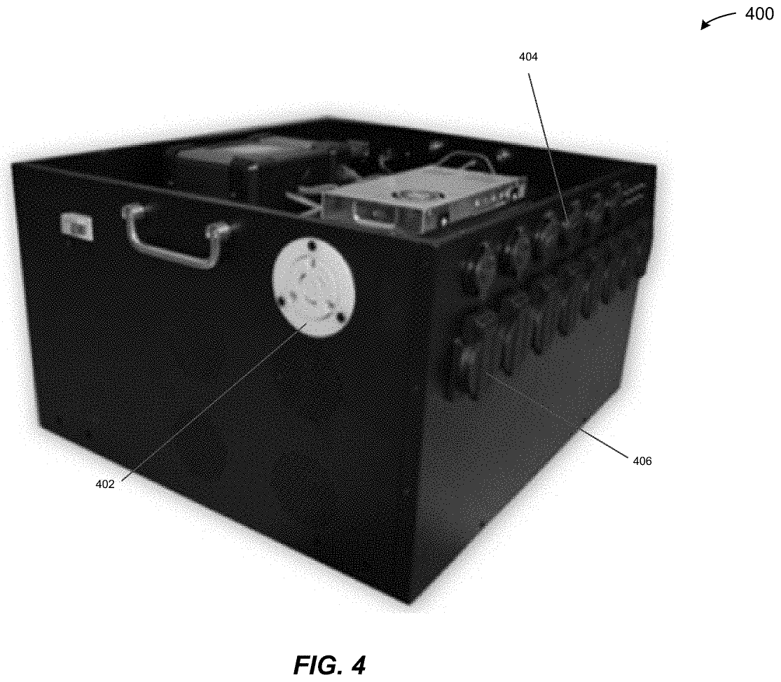

FIG. 4 is an exterior isometric view of another example modular energy storage system 400 according to some embodiments of this disclosure. According to some embodiments, various ones of system 400 may include one or more battery packs including a plurality of battery cells, one or more flywheel storage devices, or any other suitable electrical storage device as would be apparent to one having ordinary skill in the art.

According to some embodiments, an interconnection port 402 may be provided as part of system 400 and configured for the purpose of connecting the system with one or more similar systems, for example in order to scale the overall capacity of a system. Accordingly, because each module 400 is capable of receiving and discharging AC and/or DC power at a variety of voltages, even an unsophisticated end user is capable of assembling a suitable system anywhere in the world at a consistent and predictable cost, and without the need for custom design, build, and installation services, or access to a traditional power grid infrastructure. The resulting system is also highly flexible and portable, able to be scaled up and down without waste of modules or components.

According to some embodiments, various electrical ports 406 may be provided about one or more exterior surfaces of system 400. These may be any combination of AC and DC current, and one or more voltages.

According to some embodiments, one or more displays 404 may be configured to provide a user with operational and status information about system 400.

None of the descriptions in this application should be read as implying that any particular element, step, or function is an essential element that must be included in the claim scope. The scope of patented subject matter is defined only by the claims. Moreover, none of the claims is intended to invoke 35 U.S.C. 112(f) unless the exact words “means for” are followed by a participle.

What is claimed is:

1. A modular power storage system comprising:
at least one energy storage device;
an interconnection port configured for connecting the modular power storage system to one or more other similar systems;
one or more charging ports, the one or more charging ports configured collectively to receive electrical power delivered at more than one voltage; and
one or more discharge ports, the one or more discharge ports configured collectively to discharge electrical power at more than one voltage.

2. The modular power storage system of claim 1, wherein the one or more charging ports are configured to accept power from one or more of a solar power generation source, a wind generator, and a hydroelectric generator.

3. The modular power storage system of claim 1 wherein the at least one energy storage device comprises a plurality of battery cells.

4. The modular power storage system of claim 1 wherein the at least one energy storage device comprises a flywheel energy storage device.

5. The modular power storage system of claim 1 further comprising a voltage sensing device electrically coupled to at least one of the one or more charging ports.

6. The modular power storage system of claim 1, further comprising battery management safety circuitry.

7. The modular power storage system of claim 1, wherein the one or more charging ports are configured collectively to receive both alternating current and direct current simultaneously.

8. The modular power storage system of claim 1, wherein the one or more discharge ports are configured collectively to distribute both alternating current and direct current simultaneously.

9. An energy storage system comprising:
a plurality of modular power storage systems, various ones of the modular power storage systems comprising:
at least one energy storage device;
an interconnection port configured for connecting the modular power storage system to one or more other modular power storage systems;
one or more charging ports, the one or more charging ports configured collectively to receive electrical power delivered at more than one voltage; and
one or more discharge ports, the one or more discharge ports configured collectively to discharge electrical power at more than one voltage.

10. The energy storage system of claim 9, wherein the one or more charging ports are configured to accept power from one or more of a solar power generation source, a wind generator, and a hydroelectric generator.

11. The energy storage system of claim 9 wherein the at least one energy storage device comprises a plurality of battery cells.

12. The energy storage system of claim 9 wherein the at least one energy storage device comprises a flywheel energy storage device.

13. The energy storage system of claim 9, wherein the various ones of the modular power storage systems further comprise a voltage sensing device electrically coupled to at least one of the one or more charging ports.

14. The energy storage system of claim 9, further comprising a battery management system.

15. The energy storage system of claim 9, wherein the one or more charging ports are configured collectively to receive both alternating current and direct current simultaneously.

16. The energy storage system of claim 9, wherein the one or more discharge ports are configured collectively to distribute both alternating current and direct current simultaneously.

17. An energy storage system comprising:
a plurality of modular power storage systems, various ones of the modular power storage systems comprising:
at least one energy storage device;
an interconnection port configured for connecting the modular power storage system to one or more other modular power storage systems;
one or more charging ports, the one or more charging ports configured collectively to receive electrical power delivered at more than one voltage; and
one or more discharge ports, the one or more discharge ports configured collectively to discharge electrical power at more than one voltage;
one or more solar power generation panels electrically coupled to at least one of the one or more charging ports of at least one of the plurality of modular power storage systems; and
one or more electrical loads electrically coupled to at least one of the one or more discharge ports of at least one of the plurality of modular power storage systems.

18. The energy storage system of claim 17, wherein the one or more charging ports are configured to accept power from one or more of a solar power generation source, a wind generator, and a hydroelectric generator.

19. The energy storage system of claim 17 wherein the at least one energy storage device comprises a plurality of battery cells.

20. The energy storage system of claim 9, wherein the various ones of the modular power storage systems further comprise a voltage sensing device electrically coupled to at least one of the one or more charging ports.
